(19) United States
(12) Patent Application Publication
(10) Pub. No.: US 2014/0350945 A1
(43) Pub. Date: Nov. 27, 2014

(54) System and Method for Validation of Pharmaceutical Composition Formulations

(71) Applicant: Paul P. Klomp, Sugar Land, TX (US)

(72) Inventor: Paul P. Klomp, Sugar Land, TX (US)

(73) Assignee: PROFESSIONAL COMPOUNDING CENTERS OF AMERICA, Houston, TX (US)

(21) Appl. No.: 13/900,332

(22) Filed: May 22, 2013

(51) Int. Cl. G06Q 50/22; G06Q 10/08

(52) U.S. Cl. CPC G06Q 50/22; G06Q 10/087
USPC 705/2

(57) ABSTRACT

The present disclosure relates to a method for validating formulations in pharmaceutical compositions. The method may include entering inventory into the system, formulating the batch, storing batch compounding data, manufacturing the batch, assigning and printing a barcode on the pharmaceutical compositions, scanning the barcode, checking if correct chemicals are used, and correcting the pharmaceutical compositions formulation if required. The present method may prevent a batch to be produced until the batch has been corrected in cases where incorrect chemicals are used in pharmaceutical compositions, and may additionally improve accuracy and efficiency of quality control because data, such as lot numbers, does not have to be hand-typed when barcodes are scanned.

### CROSS-REFERENCE TO RELATED APPLICATIONS

N/A

### BACKGROUND

1. Field of the Disclosure

The present disclosure relates generally to pharmaceutical operations, and more specifically to a method for validating formulations in pharmaceutical compositions.

2. Background Information

In order to fulfill patient prescriptions, pharmacies stock and manage an extensive inventory of pharmaceutical products. These products are packaged in pharmaceutical product containers including any suitable type of package such as bottles, boxes, and bags, among others. To keep track of the different items in inventories, as well as for reducing number of medication errors in hospitals and healthcare centers, the FDA has specified that the packaging of all human drugs be labeled with a linear bar code including the National Drug Code (NDC) number that serves as a universal product identifier. This 10-digit code identifies the labeller/vendor, product, trade package size, the specific strength, the dosage, and the formula for a specific firm. These barcodes exhibit benefits such as improving operational efficiency, saving time for taking inventory, reducing errors, and cutting inventory costs.

Problems related with present pharmaceutical quality control include that after the scanning of barcodes, softwares generally require users to manually input the lot number of the item that was scanned or sometimes other identification data, which may lead to type-off mistakes. Additionally, when producing pharmaceuticals and scanning their barcodes, information included in the barcodes does not generally permit a system to detect if a pharmaceutical has the wrong chemicals in the right concentrations. This may cause quality control having to check for quality at the end of the manufacturing process, leading to monetary and material costs due to the disposal of many of the products in the batch. Quality control and efficiency of pharmaceutical operations are considered to be a major concern.

### SUMMARY

The present disclosure relates to a method for validating formulations in pharmaceutical compositions. The method may involve a system for validating the pharmaceutical compositions, which may include a pharmaceutical manufacturing process, a barcode scanning, sending information to a database, and having a user accessing the information through a user interface. The method for validating formulations in pharmaceutical compositions may include entering inventory into the system, formulating the batch, storing compounding data, manufacturing the batch, assigning and printing a barcode on the pharmaceutical compositions, scanning the barcode, checking if correct chemicals are used, and correcting the pharmaceutical compositions formulation if required

When producing the batch and after assigning and printing the barcode on the pharmaceutical compositions, the system may compare the original compounding data with the data on the produced pharmaceutical compositions, such that the batch may be stopped until it has been corrected, saving time and economical resources because ingredients in the batch may still be utilized. Data comparison may include factors such as chemical composition, purity, potency, waters of hydration, and loss of drying, among others. The present method may additionally improve accuracy and efficiency of quality control because data, such as lot numbers, may not need to be hand-typed when barcodes are scanned.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 is a block diagram of a pharmaceutical composition validation system, according to an embodiment.

FIG. 2 is a flowchart of a method for validating pharmaceutical compositions in a pharmaceutical manufacturing process, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms have the following definitions:

“Pharmaceutical composition” refers to a pharmaceutical dosage form, such as a tablet, capsule, and solution, among others, generally including an active ingredient in association with inactive ingredients.

“Composition validation” refers to a process for providing a high degree of assurance that pharmaceutical compositions meet predetermined specifications and quality attributes.

“Batch” refers to a specific quantity of a drug or other material that may be intended to have uniform character and quality, within specified limits, and may be produced according to a single manufacturing order during the same cycle of manufacture.

“Lot number” refers to a distinctive combination of letters, numbers, or symbols, or any combination thereof, from which a complete history of a manufacture, processing, packing, holding, and distribution of a batch or lot of pharmaceutical compositions or other material may be determined.

### Description

The present disclosure relates to a method for validating formulations in pharmaceutical compositions, which may allow the tracking of each ingredient within drugs and may stop the manufacturing process in cases where predefined characteristics in the drug do not match measured values, allowing the batch to be corrected before finishing production. Additionally, when scanning pharmaceutical compositions, data is populated in a way that there may not be need to hand-type information into the system.

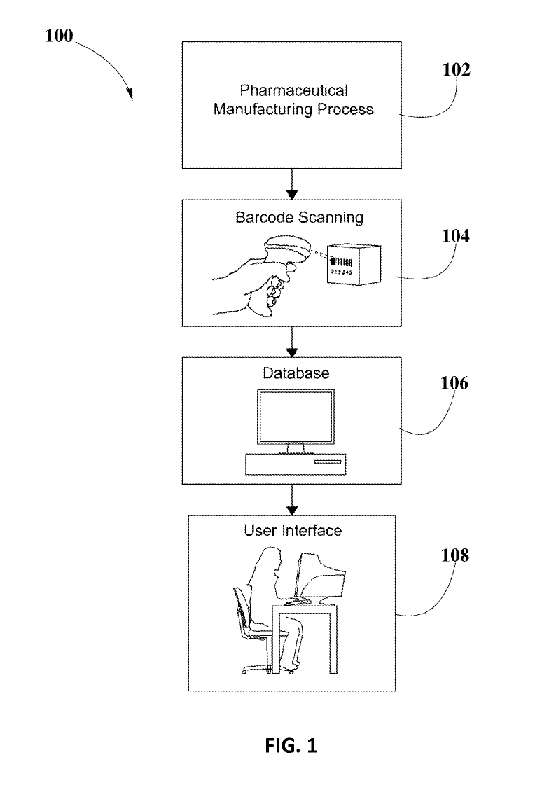

FIG. 1 is a block diagram of pharmaceutical composition validation system 100, which may include a pharmaceutical manufacturing process 102, in which, after a pharmaceutical composition may be manufactured, packaged, and a barcode has been assigned and printed on the pharmaceutical composition, a barcode scanning 104 may follow. Information from barcode scanning 104 may then go to a database 106, which may be connected to a user interface 108 that may permit a pharmacist to access the inventory and data from each pharmaceutical composition and ingredient in the manufactured batch. Additionally, database 106 may save calculations and information from pharmaceutical compositions manufactured in previous batches.

Suitable barcode symbols that may work with the principles of the present disclosure include EAN/UPC, GS1 Data Matrix, GS1 Data Bar, GS1-128, ITF-14, GS1 QR Code and Composite Component, among others.

Suitable barcode scanners 102 may come in a wide variety of form factors, including fixed location, hand-held, fixed/hand-held, wearable, pen-type, CCD readers, laser scanners, camera-based readers, and omni-directional, among others.

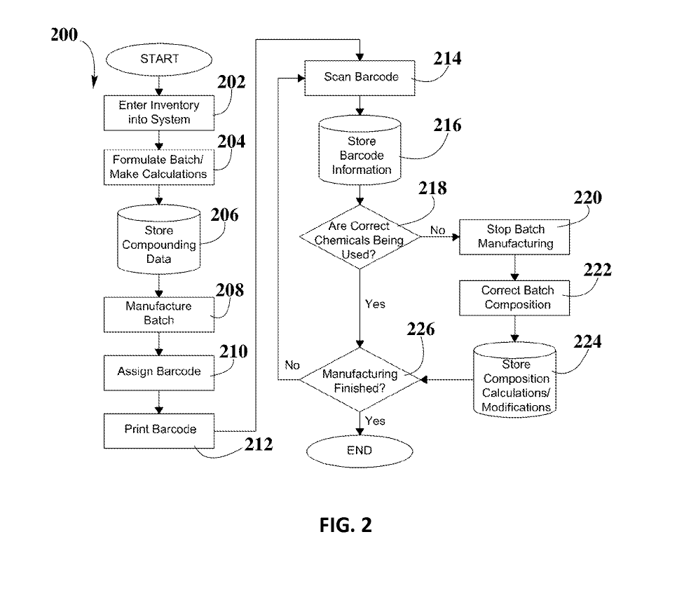

FIG. 2 is a flowchart of a method for validating pharmaceutical compositions 200 in pharmaceutical manufacturing process 102. Method for validating pharmaceutical compositions 200 may begin when the individual pharmacist in charge of producing a batch enters inventory into the system 202, which may be done every time inventory is received in the pharmacy. Subsequently, the individual pharmacist may formulate the batch 204, which may involve making necessary calculations of factors such as purity, potency, waters of hydration, and loss of drying, among others. Formulating the batch 204 may depend on production planning based on individual patient prescriptions. Information gathered for each individual ingredient in pharmaceutical compositions in the batch may then be stored in database 206, after which batch manufacturing 208 may begin.

After a pharmaceutical composition is produced, method for validating pharmaceutical compositions 200 may assign a barcode 210, which may include information of the individual pharmaceutical composition that has been produced, including aforementioned factors (purity, potency, waters of hydration, and loss of drying) and other data such as lot number, expiration date, national drug code (NDC), average wholesale price (AWP), and cost, among others. After assigning a barcode 210, a process for printing the barcodes 212 on each of the individual pharmaceutical compositions may follow. Subsequently, each barcode may be scanned 214, leading to barcode data storage 216 in a way that data is populated such that a pharmacist may have access to this data in database 106 through user interface 108. The pharmacist may have access to the inventory and to all the ingredients in the individual pharmaceutical compositions, including the ingredients' original batch, location, and concentrations, among others, without the need of hand-typing the lot number or other data, saving time and increasing data accuracy.

Method for validating pharmaceutical compositions 200 may subsequently check if correct chemicals are being used 218 within the scanned pharmaceutical composition, which may be performed by comparing predefined values for pharmaceutical compositions with values in the scanned information. If values do not match, method for validating pharmaceutical compositions 200 may proceed by stopping batch manufacturing 220 and then correcting batch composition 222. Correcting batch composition 222 may include modifying chemicals, quantities, potency, or other factors that may have varied between the data for batch formulation 204 and pharmaceutical composition characteristics in the actual batch manufacturing 208. After assuring that correct chemicals are being used with predefined characteristics, method for validating pharmaceutical compositions 200 may store the new pharmaceutical compositions calculations and modifications 224 in database 106. Finally, method for validating pharmaceutical compositions 200 may check if the manufacturing process has finished 226, in which case the process may end. Otherwise, method for validating pharmaceutical compositions 200 may scan the barcode 214 of another pharmaceutical composition until the process may end.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for validating a formulation in a pharmaceutical composition, the method comprising:
providing, to a non-transitory computer readable storage medium having encoded thereon computer executable instructions for providing at least one inventory control system, at least one batch protocol comprising at least one compound formula;
associating a unique identifier for labeling manufactured product with the at least one batch protocol;
analyzing a composition of one of the manufactured product; and
comparing the composition to the at least one compound formula;
wherein the inventory control system provides an indication of the comparison between the composition of one of the manufactured product and the at least one compound formula.

2. The method of claim 1, wherein the at least one batch protocol is changed by the indication of the comparison between the composition of one of the manufactured product to the at least one compound formula.

3. The method of claim 2, wherein a change of the at least one batch protocol comprises one selected from the group consisting of change in compound formula, compound quantity, compound potency, and combinations thereof.

4. The method of claim 1, wherein the at least one inventory control system is changed by the indication of the comparison between the composition of one of the manufactured product to the at least one compound formula.

5. The method of claim 1, wherein the comparison between the composition of one of the manufactured product and the at least one compound formula is between at least one selected from the group consisting of chemical composition, purity, potency, waters of hydration, loss of drying, and combinations thereof.

6. The method of claim 1, wherein the unique identifier comprises at least one lot number.

7. The method of claim 1, wherein the at least one compound formula comprises at least one individual ingredient attribute selected from the group comprising molar weight, name, color, interaction profile, stability profile, and combinations thereof.

8. The method of claim 1, wherein the unique identifier is a barcode.

9. The method of claim 1, wherein the unique identifier is selected from the group consisting of EAN/UPC, GS1 Data Matrix, GS1 DataBar, GS1-128, ITF-14, GS1 QR Code, and combinations thereof.

10. The method of claim 1, wherein the unique identifier is read by one selected from the group consisting of a fixed location scanner, hand-held scanner, a wearable scanner, a pen-type scanner, a CCD reader, a laser scanner, a camera-based reader, and combinations thereof.
